(19) United States
(12) Patent Application Publication
(10) Pub. No.: US 2013/0327199 A1
(43) Pub. Date: Dec. 12, 2013

(54) Rolling Tool

(71) Applicant: Dwayne EAGLE, Whitecap (CA)

(72) Inventor: Dwayne EAGLE, Whitecap (CA)

(21) Appl. No.: 13/914,428

(22) Filed: Jun. 10, 2013

Related U.S. Application Data
(60) Provisional application No. 61/658,353, filed on Jun. 11, 2012.

(51) Int. Cl. B26F 1/32

(52) U.S. Cl. CPC B26F 1/32
USPC 83/866; 492/13

(57) ABSTRACT

The present invention relates to an apparatus for rotatably retaining a roller for rolling along a work-surface. The apparatus include an axle adapted to engage the roller for rotation about a rotational axis, a first handle connected to the axle and radiating outward from the rotational axis, and a second handle connected to the axle and radiating outward from the rotational axis at an angle to the first handle. Optionally, the roller has outwardly radiating protrusions, for example to perforate drywall when the roller is rolled along a drywall surface.

### CROSS REFERENCE TO RELATED APPLICATION

This application claims priority from U.S. Provisional Patent Application Ser. No. US61/658,353 filed on Jun. 11, 2012, entitled Perforating Tool, which is expressly incorporated by reference herein to the extent permitted by law.

### BACKGROUND

1. Field

The present invention relates to rolling tools that a user rolls over a work-surface. More particularly, the present invention relates to such rolling tools that a user both rolls along a work-surface and also presses into the work-surface. Still more particularly, the present invention relates to such rolling tools that a user steers, to roll along only an intended path and not over other portions of the work-surface or adjacencies.

2. Description of Related Art

Rolling tools that roll a roller along an intended path over a work-surface are advantageous because they can work a large work-surface quickly and easily. Paint rollers and pizza wheels are examples of such tools, contrasted with brushes and a knives respectively. Such tools might include a roller that is wide or narrow, blunt or sharp, smooth or textured, hard or soft, for example. The roller might be shaped as a cylinder, a cone, a disc, or a ganged set of any such objects, for example.

One challenge with rolling tools is that such a tool can get away from its user and roll off course, particularly if the user must apply force to the roller in a direction other than along the intended path, and particularly if the user is reaching—extending the tool such that the roller is operating at a distance from the user's core. In such situations, the roller may roll off the intended path and work an unintended portion of the work-surface or an adjacency.

Drywall perforating tools provide a useful, specific illustration of the challenges presented.

Drywall is a ubiquitous building product in residential and commercial construction. In environments where drywall is exposed to high degrees of moisture, for example bathrooms, water-resistant drywall is typically used to present a sealed surface. For example, Georgia-Pacific Gypsum LLC of 133 Peachtree Street NE, Atlanta, Ga. 30303, USA produces a product known as DensShield® Tile Backer, which employs an acrylic coating on its face side to resist moisture, and more broadly liquid.

Problematically, this very moisture-resistance renders such products difficult to coat, for example with drywall mud. The work-surface tends to resist absorption of moisture in the mud coating, and as a result the coating tends to bubble. Similar problems can also occur when applying mud to a regular drywall surface that has previously been painted.

Unless such a work-surface is pretreated—perforated—numerous successive applications of a mud coating are required to obtain a quality finished surface. Such repetitive applications are time-consuming and costly as more coats of drywall mud are required than are for standard (i.e., non-moisture-resistant or non-painted) drywall products.

Rolling tools for preparing drywall surfaces for painting, papering or mudding have been known for many years. As a representative example, H. T. Parris was granted U.S. Pat. No. 3,389,466 on Jun. 25, 1968 for a Wall Surface Scarifying and Preparing Tool. Parris taught a tool very similar to a conventional paint roller, but having a spiked roller in place of an absorbent one. Elias Lebessis was granted U.S. Pat. No. 5,497,556 on Mar. 12, 1996 for a Ripping Tool. Lebessis taught a tool that is similar in many respects to Parris's, but including a protective housing surrounding part of the circumference of the spiked roller.

A user would prepare a work-surface with the Parris tool or the Lebessis tool using a single, elongated handle to roll the spiked roller, the handle having a distal end that engages the spiked roller and a proximal end that provides a grip for the user. Neither the Parris tool nor the Lebessis tool offers the user a safe second purchase, either at the spiked roller itself or via a second handle, by which the user could exert fine steering or directional control, or press the roller into the work-surface. Rolling forces, pressing forces and steering forces (including torsional forces) must all be applied at a distance via the single, elongated handle, thereby limiting user-control.

Accordingly, there remains a need for an apparatus that adequately and efficiently addresses the challenges faced when operating a rolling tool, for example to prepare drywall work-surfaces for mudding and finishing.

### SUMMARY

The present invention is directed to this need.

According to one aspect of the present invention, there is provided an apparatus for rotatably retaining a roller for rolling along a work-surface, the apparatus having: an axle adapted to engage the roller for rotation about a rotational axis; a first handle connected to the axle and radiating outward from the rotational axis; and a second handle connected to the axle and radiating outward from the rotational axis at an angle to the first handle.

The second handle may be separate from the first handle. The first handle and the second handle may be normal to the rotational axis.

The angle may not be a straight angle. The angle may be less than 135 degrees and greater than 45 degrees. The angle may be between 120 degrees and 60 degrees. The angle may be between 100 degrees and 80 degrees. The angle may be 90 degrees.

When the apparatus is oriented to be rolled along the work-surface, the first handle may aligned with respect to the axle to transmit the majority of the force applied to it parallel to the work-surface and the second handle may be aligned with respect to the axle to transmit the majority of the force applied to it normal to the work-surface.

The angle may be fixed or adjustable, for example by sliding at least one of the first handle and the second handle along a track.

The first handle and the second handle may be different lengths. At least one of the first and second handles is detachable.

At least one of the first and second handles may include a torsional grip, for example one that is T-shaped, U-shaped, Pi-shaped, or knurled.

The axle may be formed as a housing and first and second opposing hubs, each of the hubs being rotatably attached to the housing and adapted to engage an opposite end of the roller.

The apparatus may further include a roller adapted for rotatable engagement on the axle. The roller may have outwardly radiating protrusions.

According to another aspect of the present invention, there is provided a kit having an apparatus as describe above and a roller adapted for rotatable engagement on the axle of the apparatus. The roller may have outwardly radiating protrusions.

According to another aspect of the present invention, there is provided a method of rolling a roller along a work-surface, the roller being rotatably engaged on an axle for rotation about a rotational axis, a first handle connected to the axle and radiating outward from the rotational axis, and a second handle connected to the axle and radiating outward from the rotational axis at an angle to the first handle, the method having the steps of: transmitting the majority of the force applied to the first handle parallel to the work-surface and transmitting the majority of the force applied to the second handle normal to the work-surface.

Further aspects and advantages of the present invention will become apparent upon considering the following drawings, description, and claims.

### DETAILED DESCRIPTION

The invention will be more fully illustrated by the following detailed description of non-limiting, specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

### 1. BRIEF DESCRIPTION OF THE DRAWINGS

In drawings which illustrate non-limiting embodiments of the invention:

FIG. 1 is a perspective view of an apparatus for rotatably retaining a roller for rolling along a surface, in accordance with a first embodiment of aspects of the present invention.

FIG. 2 is a side elevational view of the apparatus of FIG. 1.

FIG. 3 is a front elevational view of the apparatus of FIG. 1.

FIG. 4 is a bottom plan view of the apparatus of FIG. 1.

FIG. 5 is a perspective view of an apparatus for rotatably retaining a roller for rolling along a surface, in accordance with a second embodiment of aspects of the present invention.

FIG. 6 is a perspective view of an apparatus for rotatably retaining a roller for rolling along a surface, in accordance with a third embodiment of aspects of the present invention.

FIG. 7 is a perspective view of an apparatus for rotatably retaining a roller for rolling along a surface, in accordance with a fourth embodiment of aspects of the present invention.

2. Table of Reference Numbers

| Number | Name | Name | Number |
|---|---|---|---|
| 10 | apparatus | apparatus | 10 |
| 12 | roller | axle | 14 |
| 14 | axle | first handle | 18 |
| 16 | rotational axis | first hub | 24 |
| 18 | first handle | housing | 22 |
| 20 | second handle | knurled torsional grip | 28d |
| 22 | housing | Pi-shaped torsional grip | 28c |
| 24 | first hub | protrusion | 32 |
| 26 | second hub | roller | 12 |
| 28 | torsional grip | rotational axis | 16 |
| 28a | T-shaped torsional grip | second handle | 20 |
| 28b | U-shaped torsional grip | second hub | 26 |
| 28c | Pi-shaped torsional grip | torsional grip | 28 |
| 28d | knurled torsional grip | track | 30 |
| 30 | track | T-shaped torsional grip | 28a |
| 32 | protrusion | U-shaped torsional grip | 28b |
| S | work-surface | work-surface | S |

### 3. DETAILED DESCRIPTION OF SPECIFIC EMBODIMENTS

### (a) Structure of Specific Embodiments

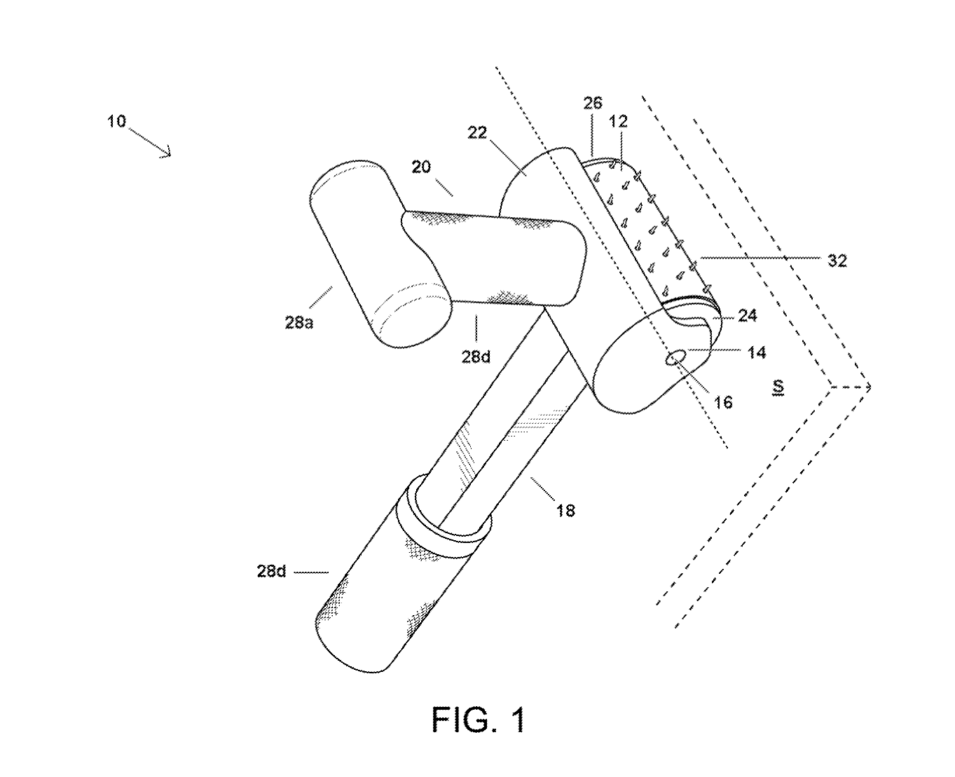

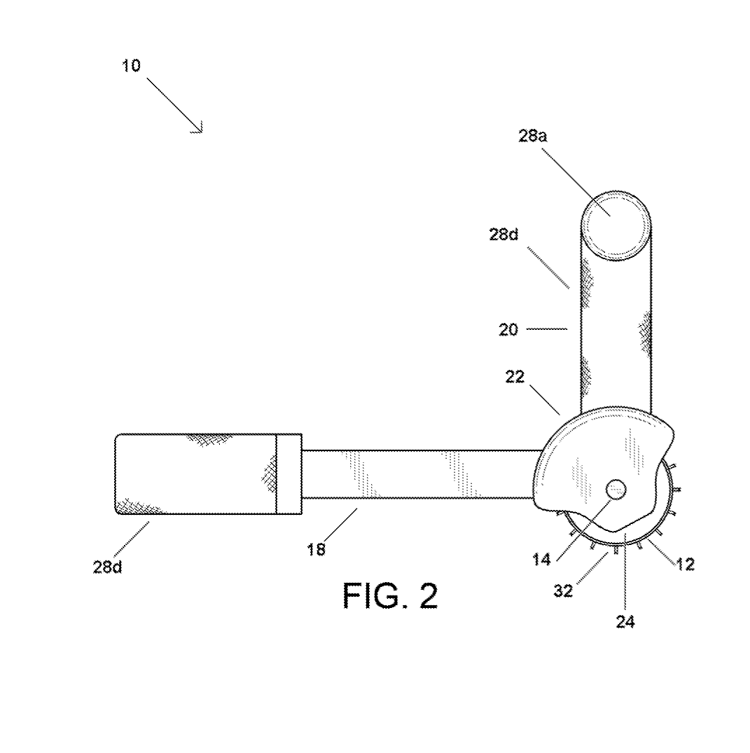

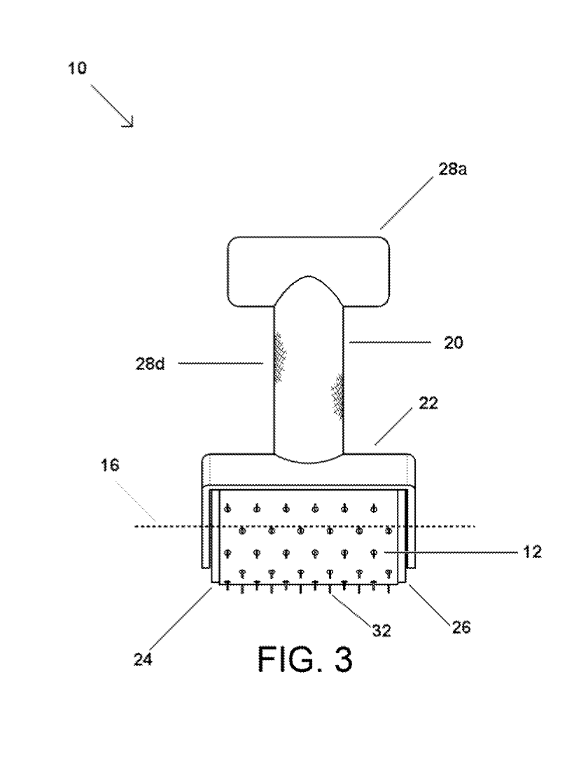

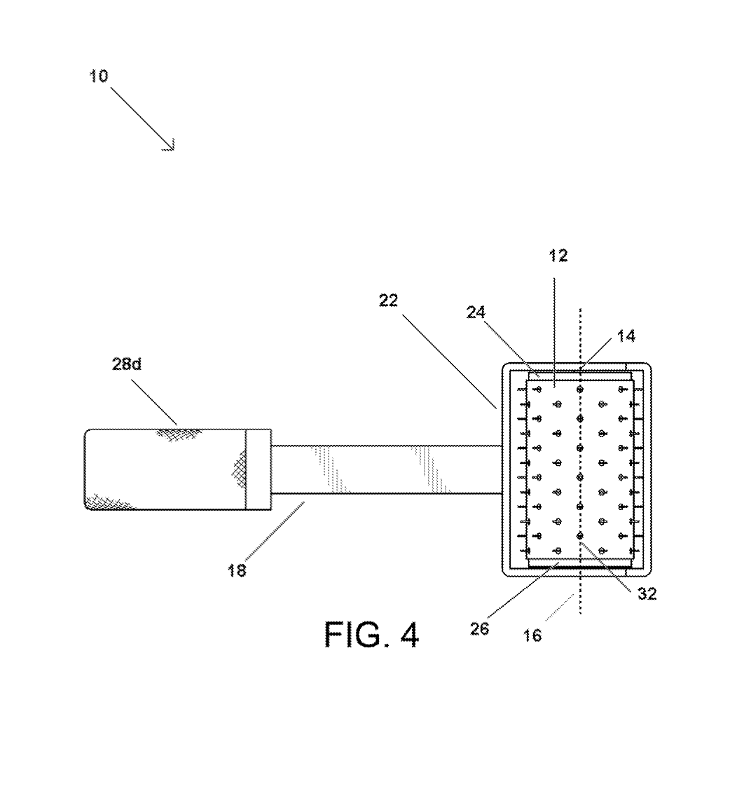

With reference to FIGS. 1-7, there will now be described various specific, exemplary, non-limiting embodiments of an apparatus 10 for rotatably retaining a roller 12 for rolling along a work-surface S, which embodiments illustrate aspects of the present invention.

FIGS. 1-4 illustrate a first embodiment of the apparatus 10, for rotatably retaining a roller 12 for rolling along a work-surface S (not part of the invention). The apparatus 10 includes an axle 14 adapted to engage the roller 12 for rotation about a rotational axis 16 that is coincident with the axle 14.

A first handle 18 extends from the axle 14, radiating outwardly from the rotational axis 16. A second handle 20 also extends from the axle 14 and radiates outwardly from the rotational axis 16 at an angle to the first handle 18. The second handle 20 may be separate from the first handle 18, as illustrated, such that each independently transmits the force applied to it toward the axle 14. As used herein, the word “handle” means that part of a thing that is made to be grasped by the hand in using or moving it.

The first handle 18 and the second handle 20 may be normal to the rotational axis 16 as shown. The angle between the first handle 18 and the second handle 20 may be an angle other than a straight angle, for example an angle less than 135 degrees and greater than 45 degrees, or more narrowly an angle between 120 degrees and 60 degrees, or more narrowly an angle between 100 degrees and 80 degrees, or more narrowly an angle equal to 90 degrees.

The first handle 18 may be aligned with respect to the axle 14 to transmit the majority of the force applied to it parallel to the work-surface S when the apparatus 10 is oriented to be rolled along the work-surface S, for urging the apparatus 10 and hence the roller 12 along the work-surface S. The second handle 20 may be aligned with respect to the axle 14 to transmit the majority of the force applied to it normal to the work-surface S when the apparatus 10 is oriented to be rolled along the work-surface S, for urging the apparatus 10 and hence the roller 12 into the work-surface S.

The axle 14 may include a housing 22 that supports a first hub 24 and an opposite second hub 26. Each of the hubs 24, 26 may be rotatably attached to the housing 22 and adapted to engage an opposite end of the roller 12. The hubs 24, 26 and housing 22 may be formed from a one-piece construction or alternately, they may constitute separate components that have been connected together to assume their necessary functionality.

Those skilled in the art will recognize that the axle 14 described is just one of many ways to rotatably couple a roller to two handles, without departing from the spirit of the present invention. For example a roller might have closed ends analogous to the opposing hubs 24, 26, and be retained within a housing by pins or a through-axle rotatably engaging the respective centers of the closed ends.

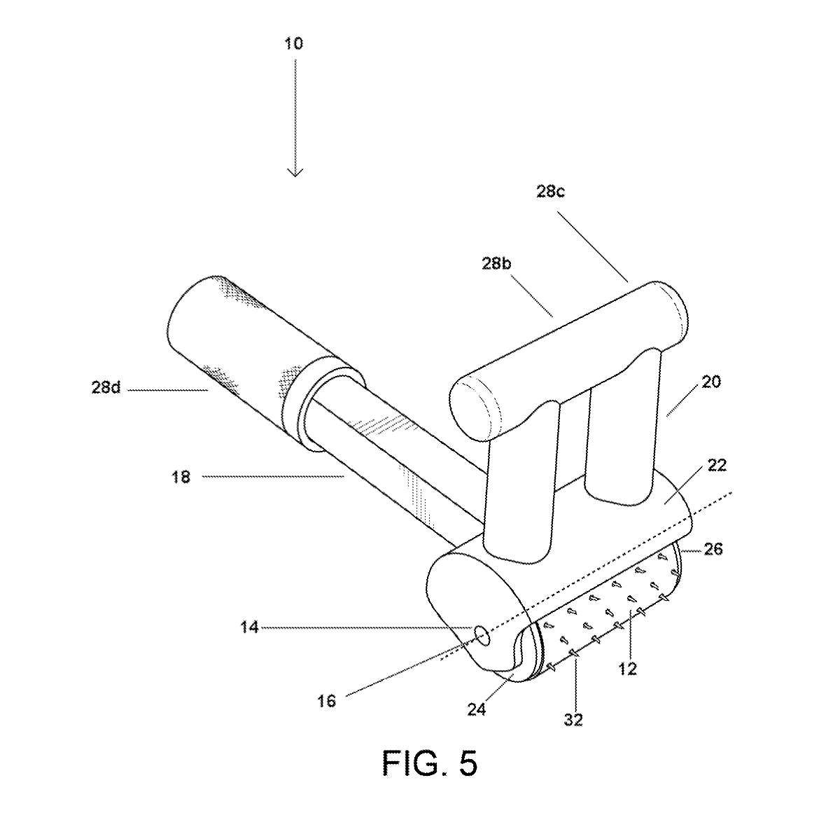

At least one of the handles 18, 20 may include a torsional grip 28 as a way for a user to apply torsional force to help control the operation of the apparatus 10, as will be described further below. For example, the torsional grip 28 may be formed as a T-shaped torsional grip 28a (see FIGS. 1-4, 6 and 7), a U-shape torsional grip 28b (see FIG. 5), a Pi-shape torsional grip 28c (see FIG. 5), or a knurled torsional grip 28d (see FIGS. 1-7), for example. Persons skilled in the art will appreciate that there are many suitable gripping variants; for example, a rubber grip surface may be employed on either one or both of the handles 18, 20.

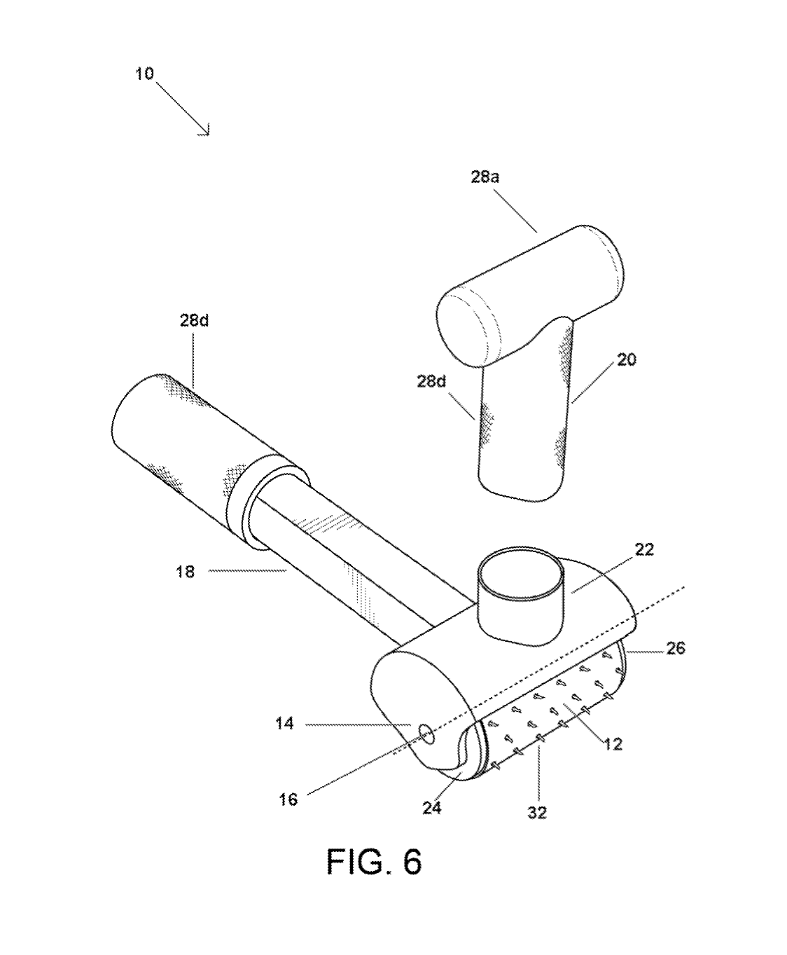

The handles 18, 20 may be of different length; for example, the first handle 18 may be longer than the second handle 20, as illustrated. As best seen in FIG. 6, at least one of the handles 18, 20 or a portion thereof may be detachable from the housing 22.

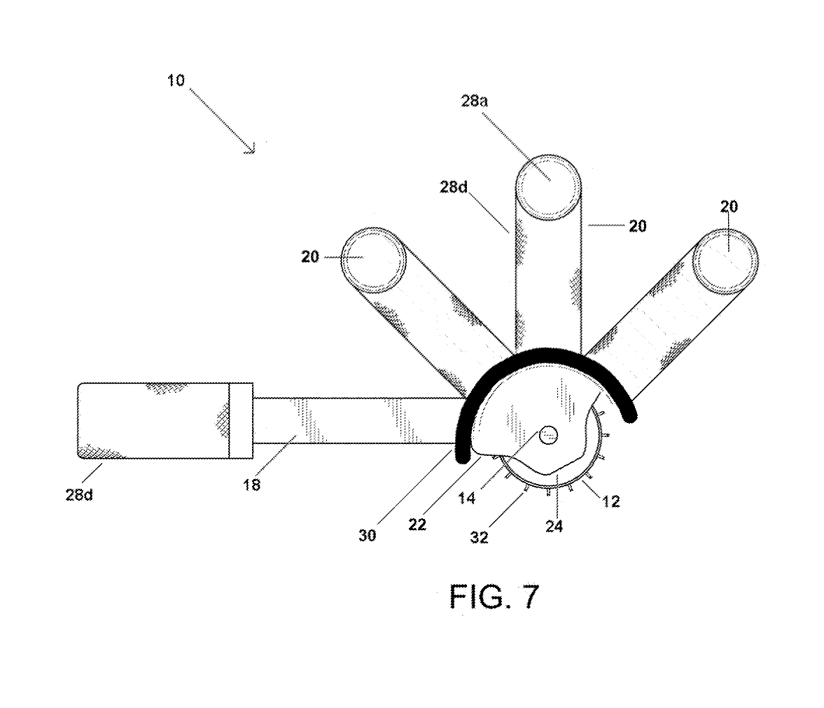

As best seen in FIGS. 1-6, the angle between the first handle 18 and the second handle 20 may be fixed. As best seen in FIG. 7, the angle between the first handle 18 and the second handle 20 may be adjustable, for example in a range greater than 45 degrees and less than 135 degrees, for example along a track 30, for example fixed to the housing 22.

The roller 12 may be included or not included with the apparatus 10. There may be provided for example a kit that includes an apparatus 10 substantially as described herein and a roller 12 adapted for rotatable engagement on the axle 14 of the apparatus 10. In any case, the roller 12 may include a plurality of outwardly radiating protrusions 32, for example to perforate drywall.

### (b) Operation of Specific Embodiments

With reference now to FIGS. 1 to 7, the operation of the apparatus 10 disclosed herein will now be described.

The user retains a roller 12 on the axle 14 in the apparatus 10 by engaging the roller 12 between the opposing first and second hubs 24, 26. The roller 12 might have been acquired independently of the apparatus 10 or together with the apparatus 10 as a kit.

The user grips the first handle 18 and the second handle 20, generally with a first and second hand respectively; however, other arrangements are possible. For example, a first user could grip the first handle 18 with a first hand and a second user could grip the second handle 20 with a second hand.

With the apparatus placed against the work-surface to be rolled there-along, the first handle 18 is aligned with respect to the axle 14 to transmit the majority of the force the user applies to it parallel to the work-surface S, thereby urging the apparatus 10 and hence the roller 12 along the work-surface S. The second handle 20 is aligned with respect to the axle 14 to transmit the majority of the force the user applies to it normal to the work-surface S when the apparatus 10 is rolled along the work-surface S, thereby urging the apparatus 10 and hence the roller 12 into the work-surface S.

This arrangement of the two handles 18, 20 encourages a user to control the rolling motion of the roller 12 with the first handle 18 with a first hand and the pressure on the roller 12 with second handle 20 with a second hand. The user can use either or both handles 18, 20 to steer the roller 12, including by applying a torque via the torsional grips 28, thereby promoting convenient and precise directional control.

Varying the angle between the handles 18, 20 provides a user with the ability to customize the preferred angle as suits a user, jobsite or a task, to better direct the desired force vectors through the handles 18, 20. By using handles 18, 20 of different length (or choking-up on a long handle) a user can similarly direct force vectors to suit. In this regard a user might detach one of the handles 18, 20 and substitute one of a length better suited to the task at hand—for example extending his reach with a long handle or using a short handle for finer control. Additionally, the user might detach one of the handles 18, 20 for convenient storage, or replacement if worn.

In this way, the user performs a method of rolling a roller 12 along a work-surface S, the roller 12 being rotatably engaged on an axle 14 for rotation about a rotational axis 16, a first handle 18 connected to the axle 14 and radiating outward from the rotational axis 16, and a second handle 20 connected to the axle 14 and radiating outward from the rotational axis 16 at an angle to the first handle 18, the method comprising: transmitting the majority of the force applied to the first handle 18 parallel to the work-surface S and transmitting the majority of the force applied to the second handle 20 normal to the work-surface S.

### (c) Description Summary

Thus, it will be seen from the foregoing embodiments and examples that there has been described a way to control a rolling tool, for example to perforate work-surfaces such as drywall, using an apparatus substantially as described herein.

While specific embodiments of the invention have been described and illustrated, such embodiments should be considered illustrative of the invention only and not as limiting the invention as construed in accordance with the accompanying claims. It will be understood by those skilled in the art that various changes, modifications and substitutions can be made to the foregoing embodiments without departing from the principle and scope of the invention is expressed in the claims made herein.

What is claimed is:

1. An apparatus for rotatably retaining a roller for rolling along a work-surface, comprising:
a. an axle adapted to engage the roller for rotation about a rotational axis;
b. a first handle connected to the axle and radiating outward from the rotational axis; and
c. a second handle connected to the axle and radiating outward from the rotational axis at an angle to the first handle.

2. An apparatus as claimed in claim 1, wherein the second handle is separate from the first handle.

3. An apparatus as claimed in claim 2, wherein the first handle and the second handle are normal to the rotational axis and the angle is not a straight angle.

4. An apparatus as claimed in claim 3, wherein the angle is less than 135 degrees and greater than 45 degrees.

5. An apparatus as claimed in claim 3, wherein the angle is between 120 degrees and 60 degrees.

6. An apparatus as claimed in claim 3, wherein the angle is between 100 degrees and 80 degrees.

7. An apparatus as claimed in claim 3, wherein the angle is 90 degrees.

8. An apparatus as claimed in claim 3, wherein, when the apparatus is oriented to be rolled along the work-surface:
a. the first handle is aligned with respect to the axle to transmit the majority of the force applied to it parallel to the work-surface; and
b. the second handle is aligned with respect to the axle to transmit the majority of the force applied to it normal to the work-surface.

9. An apparatus as claimed in claim 8, wherein the first handle and the second handle are different lengths.

10. An apparatus as claimed in claim 8, wherein the angle is fixed.

11. An apparatus as claimed in claim 8, wherein the angle is adjustable.

12. An apparatus as claimed in claim 11, wherein the angle is adjustable by sliding at least one of the first handle and the second handle along a track.

13. An apparatus as claimed in claim 8, wherein at least one of the first and second handles includes a torsional grip.

14. An apparatus as claimed in claim 13, wherein the torsional grip is at least one of:
a. T-shaped,
b. U-shaped,
c. Pi-shaped, and
d. knurled.

15. An apparatus as claimed in claim 8, wherein the axle comprises:
a. a housing, and
b. first and second opposing hubs, each of the hubs being rotatably attached to the housing and adapted to engage an opposite end of the roller.

16. An apparatus as claimed in claim 8, wherein at least one of the first and second handles is detachable.

17. An apparatus as claimed in claim 8, further comprising a roller adapted for rotatable engagement on the axle.

18. An apparatus as claimed in claim 17, wherein the roller has a plurality of outwardly radiating protrusions.

19. A kit comprising:
a. an apparatus as claimed in claim 8; and
b. a roller adapted for rotatable engagement on the axle of the apparatus.

20. A kit as claimed in claim 19, wherein the roller has a plurality of outwardly radiating protrusions.

21. A method of rolling a roller along a work-surface, the roller being rotatably engaged on an axle for rotation about a rotational axis, a first handle connected to the axle and radiating outward from the rotational axis, and a second handle connected to the axle and radiating outward from the rotational axis at an angle to the first handle, the method comprising:
a. transmitting the majority of the force applied to the first handle parallel to the work-surface; and
b. transmitting the majority of the force applied to the second handle normal to the work-surface.
